(19) United States
(12) Patent Application Publication
(10) Pub. No.: US 2011/0057840 A1
(43) Pub. Date: Mar. 10, 2011

(54) Method of Positioning RFID Tags

(75) Inventor: Chien-Ho Ko, Pingtung (TW)

(73) Assignee: National Pingtung University of Science and Technology, Pingtung (TW)

(21) Appl. No.: 12/555,921

(22) Filed: Sep. 9, 2009

(30) Foreign Application Priority Data
Sep. 9, 2009 (TW) 97134617

(51) Int. Cl. G01S 3/02

(52) U.S. Cl. 342/450

(57) ABSTRACT

A method of positioning a RFID tag by using four antennas associated with an algorithm is disclosed. A diagram is depicted, which is about relationships between the RSSI and distance according to environment of the space. Next, four antennas are arranged in the space. Four measured distances analyzed from the RSSI curve are measured. Thereafter, a position of the RFID tag is assumed at the center of space. The position is served as an initial coordinate. Subsequently, the root mean square error (RMSE) is determined. If the RMSE is small than or equal to termination criteria, the coordinate is regarded as the position of the RFID tag, otherwise the initial 3-D coordinate is updated by adding some correcting values at each measuring weight. This process is repeated till the RMSE meets the assigned condition.

### FIELD OF THE INVENTION

The present invention is relates to a RFID tag, particularly, to a positioning method using an algorithm.

### BACKGROUND OF THE INVENTION

Nowadays, communication over wireless technique is widely applied on our daily lives. It brings us extreme convenience and usefulness on many aspects. Positioning is an example of applying the wireless technique. The known techniques about positioning include global positioning system (GPS), Cell identification, infrared, IEEE 802.11, supersonic, Ultra-wideband, Zig-bee, radio frequency identification (RFID), etc. GPS provides precisely positioning with low cost, however, it is appropriate for outdoor use only. Cell ID and super-wide band are apt in large district positioning. Infrared position is known for environmental interference-prone and high cost for apparatus installation. The performances of IEEE 802.11 and Zig-Bee techniques in positioning have been found not as good as expectation. Cost for constructing a supersonic positioning system is usually expensive.

RFID positioning system is an automatic identification system without direct contact. The RFID tag broadcasts radio frequency out so as to transmit identification message. An identification system is composed of RFID tags and readers. Each RFID tag contains a circuit thereon so that a reader can access the information written on the RFID tags in distant using radio frequency. RFID tag essentially is a silicon chip with a simple antenna formed thereon and then capsulated by glass or plastic film.

A RFID system for indoor positioning was first proposed by HighTower and Borriello in 2001. The research developed a SpotON positioning system to verify the feasibility of using RFID in indoor positioning. In the method of SpotON, unknown positions are not processed by the central control console but are approached by many local detectors. The respond signals, i.e. RSSI (radio signal strength indicator), transmitted from many local detectors distributed in the environment are collected. The RSSI is then analyzed by a positioning algorithm to determine the positions of the article.

RFID positioning is especially apt to indoor use by taking advantage of low cost for system setup. In 3-D (three dimensional) space, for positioning a target RFID tag, one RFID antenna can constitute a sphere surface only and two RFID antennas can constitute a joint area of two spheres. The third additional antenna can further position the target to two possible answers. To obtain a merely reasonable solution, four antennas are generally demanded.

Referring to FIG. 1, it shows three signal transmitter (or stations) with known positions provided to locate a target tag. Each transmitter transmitting a radio signal outward constitutes a sphere as is shown in figure. The coordinate of the transmitters are respectively, located at (X=0,Y=0), (X=1,Y=0), and (X=3,Y=0). The coverage radiuses of them are r1, r2, and r3, respectively. The unknown position can be determined by the intersection of them. With the same concept, utilizing four transmitters to transmit signals are generally called Multilateration.

### SUMMARY OF THE INVENTION

The present invention discloses a method of positioning a RFID tag by using four antennas associated with an algorithm. At first, a diagram is made, which is about the RSSI versus distance according to environment of the space having a target RFID tag to be positioned therein. Next, four antennas are arranged in the positioning space. Utilizing the RSSI curve and four antennas, four measured distances between the RFID tag and the antennas can be obtained.

Thereafter, a position of the RFID tag is assumed and served as an initial 3-D coordinate for processing iteration. Thus, four distances between the initial 3-D coordinate to the antennas are calculated. Preferably, the initial position is assumed at the center of the space so as to save the iteration time for positioning.

The errors that are the differences between the measured distances and the calculated distances corresponding for each antenna are calculated.

Subsequently, the root mean square error (RMSE) is determined. If the RMSE is small than or equal to termination criteria, the initial coordinate is the position of the RFID tag to be determined, otherwise the initial 3-D coordinate is updated by adding some correcting values to each weighting axis. Thereafter, the errors and RMSE are updated according to the newly 3-D coordinate.

The forgoing iteration processes are repeatedly until the RMSE meets the required condition.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a schematically diagram for 3-D RFID spatial positioning according to prior art.

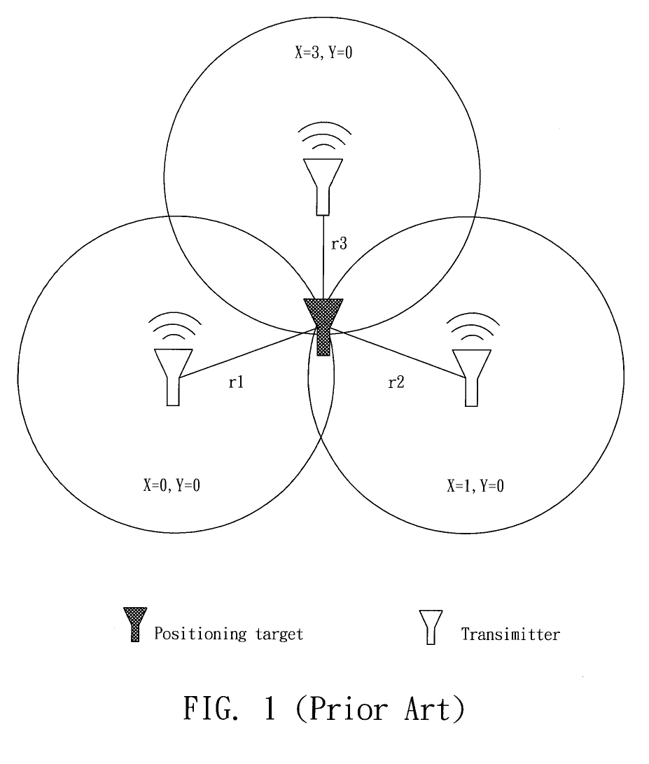

FIG. 2 shows a flow chart in accordance with the algorithm (SPA 1.0) of the present invention.

FIG. 3 shows curves illustrating the convergent tendency during the iteration processes with an initial position at a corner of the positioning space in accordance with the present invention.

FIG. 4 shows a curve illustrating the error tendency versus iteration times with an initial position at a corner of the positioning space in accordance with algorithm (SPA 1.0) of the present invention.

FIG. 5 shows the trace of positioning with an initial position at a corner of the positioning space in accordance with algorithm (SPA 1.0) of the present invention.

FIG. 6 shows a coordinate tendency versus iteration times with an initial position at a center of the positioning space in accordance with algorithm (SPA 1.0) the present invention.

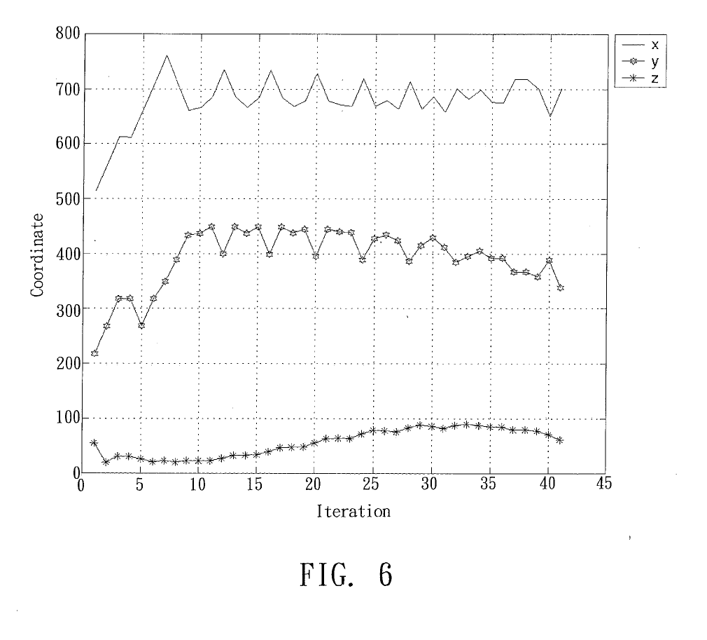

FIG. 7 shows a curve illustrating the error tendency versus iteration times with an initial position at a center of the positioning space in accordance with algorithm (SPA 1.0) of the present invention.

FIG. 8 shows the trace of 3-D positioning with an initial position at a center of the positioning space in accordance with algorithm (SPA 1.0) of the present invention.

### DETAILED DESCRIPTION OF THE PREFERRED EMBODIMENT

RFID reader including an antenna can be used to read radio frequency strength indicators (RSSI) emitted from the RFID tags. By means of RSSI, the distance can be determined but the precise position is still unknown. Thus as forgoing description in the background of the invention, at least three antennas are needed (but two positions may still occur).

The present invention utilizes RSSI of the target tag and reference tag to calculate the distance between the reader and the target tag.

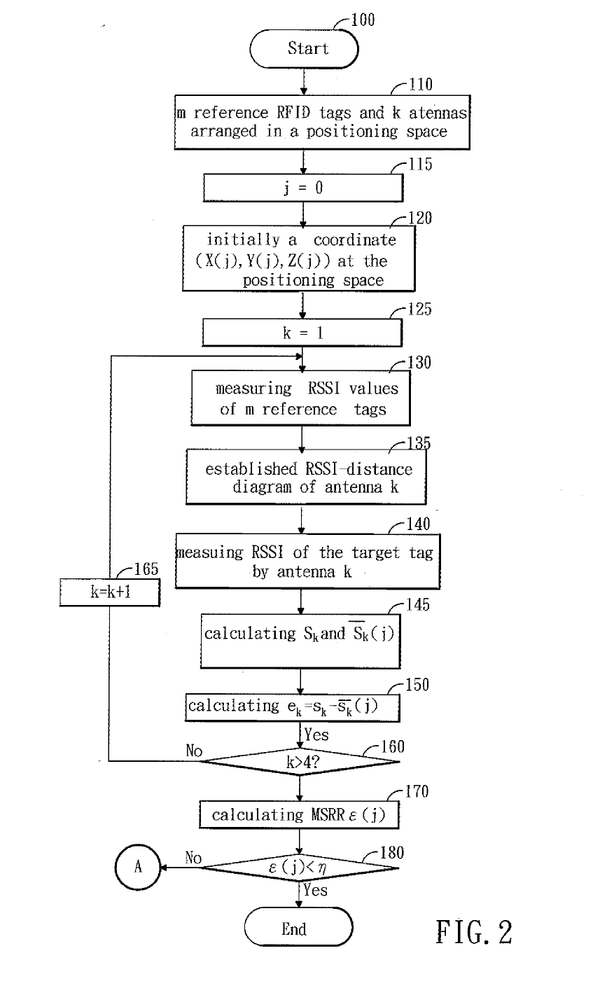

The present invention provides an algorithm called SPA 1.0 thereby spatially positioning the RFID tag. Please refer to FIG. 2. It shows a flow chart according to the algorithm of the present invention.

The method begins from the step 100. In step 110, n reference tags and m antennas are arranged in an indoor space having a RFID target tag to be poisoned.

In step 115, let j=0

In step 120, assuming the coordinate of the target tag is located at (Xi(j),Yi(j),Zi(j)) after iteration for j times where i represents the reader i. For the purpose of expediting convergence speed for targeting the position (so as to save the run time), the center of the space is assumed. It may be the shortest distance between the correct position of the target tag and the initial coordinate with such assumption. The coordinate can then be written as Xi(j)=x_{c}: Yi(j)=y_{c}; Zi(j)=z_{c}

$$( {x}_{c} , {y}_{c} , {z}_{c} ) = \{ \begin{matrix}{x}_{c} = \frac{( {x}_{i} - {x}_{e} )}{2} \\ {y}_{c} = \frac{( {y}_{i} - {y}_{e} )}{2} \\ {z}_{c} = \frac{( {z}_{i} - {x}_{e} )}{2}\end{matrix}$$

Where (xᵢ,yᵢ,zᵢ) is a coordinate of a corner, e.g. an original point of coordinate axes in the positioning space and (xₑ,yₑ,zₑ) is a coordinate of another corner diagonal to the corner, i.e. the end of the coordinate axes in positioning space.

In step 125, let k=1. In step 130, the radio signal strength indication (RSSI) of all of the reference tags are, respectfully, measured by the antenna k.

In step 135, the curve for radio signal strength decay versus distance is depicted. Using this diagram, it is easily to calculate distance between target tag and antenna since the positions of all reference tags and the antenna k are known. The diagram is also necessary since the signal of the RFID is prone to be affected or vary by the environment. Every reference tag has its identification; therefore, the antenna k can easily distinguish the RSSI signal emitted from the individual reference tag. In a preferred embodiment, nine reference tags are arranged in the positioning space.

The RSSI of the target tag is measured by the antenna k, as seen in step 140.

Accordingly, the measured distance Sᵢₖ between the antenna k and the target tag i can be determined by means of radio signal strength decay and the RSSI of the target tag. Next, the calculated distance S̅ᵢₖ between the antenna k and the position at j^{th} iteration is determined, as seen in step 145.

Subsequently, as seen in step 150, the difference between the Sᵢₖ and S̅ᵢₖ called error eₖ is calculated, as follows:

eₖ=(Sᵢₖ− S̅ᵢₖ)

In step 160, a judgment of k>4 is made. If it is true, then go to step 170, otherwise, go to step 165.

In step 165, let k=k+1 then go back to step 135.

In step 170, the root mean square error (RMSE) for all of the antennas and the target tag i is calculated using the equation:

$${ɛ}_{i} = \sqrt{\frac{{\sum }_{k = 1}^{m} {( \frac{{S}_{ik} - {\overline{S}}_{ik}}{{S}_{ik}} )}^{2}}{m}}$$

Where m is a number of RFID antennas in the positioning space.

In step 180, a decision step of ε(j)<η is made. The value η is a predetermined value set by the user. It represents the criteria value that user can accepted for the positioning. If it is true, the (Xᵢ(j),Yᵢ(j), Zᵢ(j)) is regarded as coordinate of the target. Otherwise, the step goes to step 200 for further correcting the position of the target tag.

In step 200, let k=1.

In step 210, a correcting quantity (Δxᵢ(j), Δyᵢ(j), Δzᵢ(j)) is added to the coordinate (Xᵢ(j), Yᵢ(j),Zᵢ(j)) of j^{th} iteration.

The results of equation are as follows:

$$( {x}_{i} ( j + 1 ) , {y}_{i} ( j + 1 ) , {z}_{i} ( j + 1 ) ) = \{ \begin{matrix}{x}_{i} ( j + 1 ) = {x}_{i} ( j ) + Δ {x}_{i} ( j ) \\ {y}_{i} ( j + 1 ) = {y}_{i} ( j ) + Δ {y}_{i} ( j ) \\ {z}_{i} ( j + 1 ) = {z}_{i} ( j ) + Δ {z}_{i} ( j )\end{matrix}$$

Wherein the correcting quantity (Δxᵢ(j),Δyᵢ(j),Δzᵢ(j)) is assumed to be a product of adjustability (αₓ,α_{y},α_{z}), current coordinate (xᵢ(j),yᵢ(j),zᵢ(j)), and local gradient (δₖ). It is thus expressed as:

$$( Δ {x}_{i} ( j ) , Δ {y}_{i} ( j ) , Δ {z}_{i} ( j ) ) = \{ \begin{matrix}Δ {x}_{i} ( j ) = {α}_{x} {x}_{i} {δ}_{k} \\ Δ {y}_{i} ( j ) = {α}_{y} {y}_{i} {δ}_{k} \\ Δ {z}_{i} ( j ) = {α}_{z} {z}_{i} {δ}_{k}\end{matrix}$$

Where αₓ,α_{y},α_{z} are respectively, adjustability at X-axis, Y-axis, and Z-axis. Each value is ranging from 0.000001 to 0.1 according to the size of the positioning space. A larger adjustability is preferred initially but a value about one or two order or multitude smaller than the previous adjustability will be selected if the coordinate of the (j+1)^{th} iteration is out of the positioning space.

The local gradient (δₖ) of the antenna k can be determined from S̅ᵢₖ and eₖ. The equation is as follows:

δₖ= S̅ᵢₖ×eₖ

In step 220, the coordinate (xᵢ(j+1), yᵢ(j+1),zᵢ(j+1)) of the (j+1)^{th} iteration is set as a new initial coordinate. That is:

(Xᵢ(j),Yᵢ(j),Zᵢ(j))=(xᵢ(j+1),yᵢ(j+1),zᵢ(j+1))

In step 230, the error eₖ=(Sᵢₖ− S̅ᵢₖ) is recalculated, which is the difference between the measuring distance and calculated distance after the j^{th} iteration.

In step 240, a judgment of k>4 is made. If it is true, then go to step 250, otherwise, go to step 245.

In step 245, let k=k+1 then go back to step 210.

In step 250, a RMSE for m antennas and the target tag i is calculated as above.

In step 260, a decision step of ε(j)<η is made. If it is true, the coordinate (Xᵢ(j),Yᵢ(j),Zᵢ(j)) is regarded as position of the target, otherwise, go back to step 265. For an indoor space as concerned, a predetermined value θ ranging from 5 cm to 15 cm is generally acceptable. The smaller the value θ is, the more precision of position can expect. But it costs more iteration times.

In step 265, let j=j+1 and then go back to step 200.

The step 270 is an ending step.

To verify the feasibility of the aforementioned algorithm 1.0 (SPA 1.0) for spatially positioning, a simulation flow is run. In the experiment, a space with a size of 926 cm×535 cm×211 cm is assumed and the target tag is placed at the coordinate (694 cm, 400 cm, 75 cm).

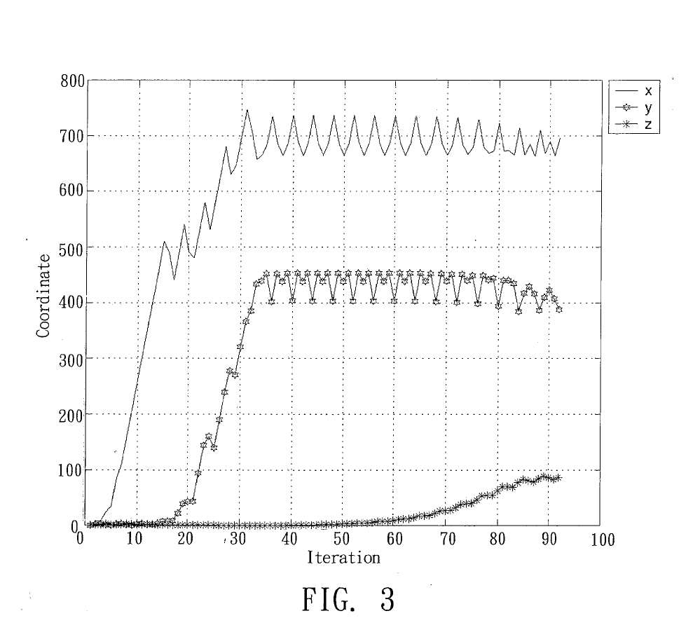

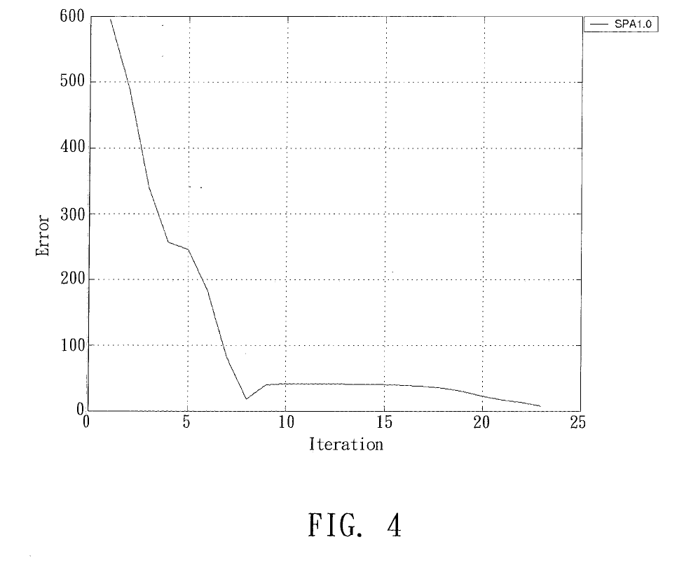

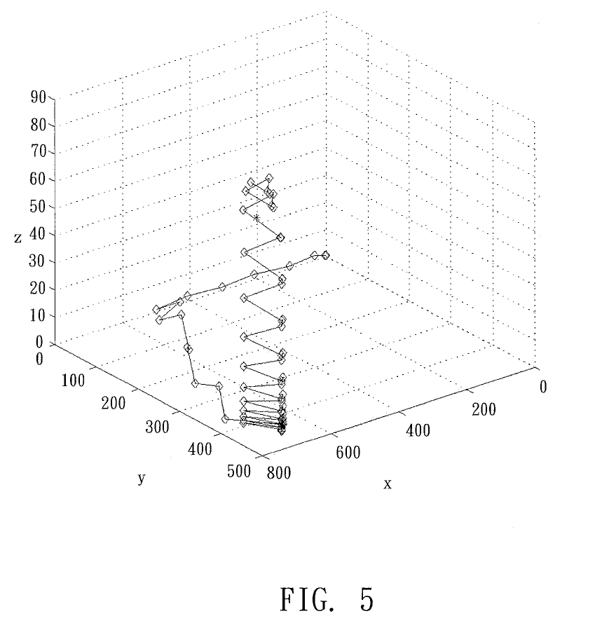

At first, the initially coordinate is set at (1,1,1). The search tendency of the SPA 1.0 algorithm is shown in FIG. 3. In FIG. 3, the curves of x, y, and z represent the distribution values in each iteration. The parameters of αₓ,α_{y},α_{z} are set as αₓ=α_{y}=α_{z}=5×10⁻⁵. Viewing from FIG. 3, the initial x and y coordinates are far from the x and y coordinates of the target tag so that the convergent processes show them approaching the true x, and y coordinates initially. After the tendency of x and y coordinate approaching stable, the convergence of z coordinate starts. The tendency of the error versus iterations is shown in FIG. 4. In FIG. 4 it shows the method using steepest gradient correction can be successfully used in the spatial positioning. The 3-D variations are shown in FIG. 5. In FIG. 5, the trace shows that the estimated coordinates are gradually converged to the target position.

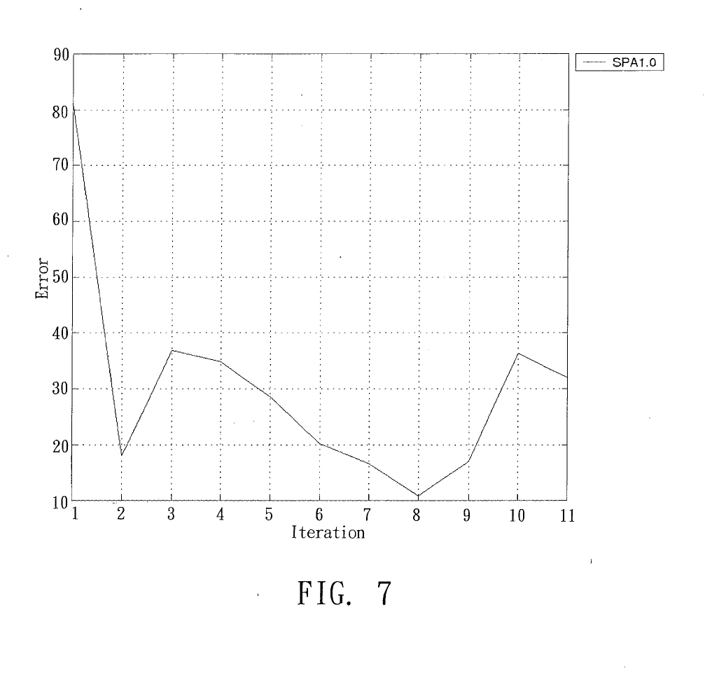

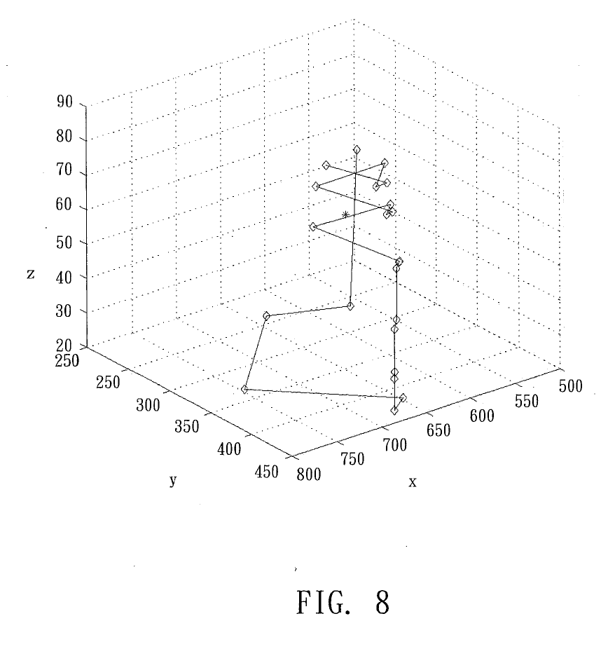

Another initial position is assumed. The starting position is at the center point (463,267.5,105.5) of the positioning space. In case of the starting coordinate at the center of the positioning space, the estimated coordinates for x-axis, y-axis, and z-axis are converged simultaneously and toward the target position. Hence the number of iterations is smaller than the initial position at a corner such as coordinate (1,1,1). Thus it is found that starting position assumed to be at the center point is appreciated. It can save the run time. The tendency of the error versus iterations is shown in FIG. 7. Referring to FIG. 8, it shows the trace of the convergence. The amplitudes of the oscillation for initial position at a center point is smaller than those of initial position at the point (1,1,1). Thus, it proves the initial poison at the center of the positioning space can meet a better convergent condition.

As is understood by a person skilled in the art, the foregoing preferred embodiment of the present o invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

What is claimed is:

1. A method of positioning a RFID tag, said method comprising the steps of:
arranging four antennas in a space having a RFID tag to be positioned therein so that four measured distances between said antennas to said RFID tag are measured;
performing an initial 3-D coordinate guessing for said RFID tag so that four calculated distance between said antennas to said initial coordinate are calculated;
calculating errors, each of which is a difference between each one of said calculated distances and a corresponding one of said measured distance;
calculating a root means square error of said errors;
judging if said means square root of said errors is larger than a first criteria, then performing a correction by adding a first, second, and third quantity to said x-coordinate, y-coordinate, and z-coordinate of said initial 3-D coordinate, said first, second, and third quantity each being, respectively, a product of adjustability, a local gradient, and corresponding one of said x-coordinate, y-coordinate, and z-coordinate so that said 3-D coordinate is updated;
updating said errors according to said updated 3-D coordinate;
updating said root means square error of said updated errors;
performing said correction again if said updated root means square error of said errors is larger than said first criteria so that a newly updated 3-D coordinate is generated which is an updating of said updated 3-D coordinate;
performing above updating steps repeatedly until said newly updated 3-D coordinate is equal to or smaller than said first criteria, then said newly updated 3-D coordinate is served as said 3-D coordinate of said RFID tag.

2. The method according to claim 1 further comprising steps of establishing relationships between RSSI and distance in accordance with the environment of said space.

3. The method according to claim 2 wherein said relationships between RSSI and distance is performed by arranging a plurality of references RFID tags in said space.

4. The method according to claim 2 wherein said four measured distances are obtained according to said relationships between RSSI and distance.

5. The method according to claim 1, wherein said adjustability is ranging from 0.000001 to 0.1.

6. The method according to claim 1, wherein said local gradient is a product of calculated distance and said error for each antenna.

7. The method according to claim 1, wherein said initial coordinate is a center of said space.

8. The method of positioning a RFID tag, wherein said method comprises the step of:
(a) letting j=0;
(b) letting a center of a space having a RFID tag to be positioned therein being a coordinate of jth iteration and expressed as (X(j),Y(j),Z(j));
(c) letting k=1;
(d) measuring a distance between an antenna k and said RFID tag Sₖ and calculating a estimated distance S̅k(j) where the distance is between said antenna k and said (X(j),Y(j),Z(j));
(e) calculating error for said antenna k eₖ(j)=Sₖ− S̅k(j);
(f) repeating the steps of (d) to (e) till all antennas eₖ(j) are calculated;
(g) calculating root mean square error ε(j);
(h) going to a step (i) if said ε(j)>η, otherwise, said (X(j),Y(j),Z(j)) is regarded as the position of said RFID tag, wherein said η is a predetermined criteria;
(i) calculating correcting values Δx(j), Δy(j), Δz(j);
(j) letting (X(j+1),Y(j+1),Z(j+1)=(X(j)+Δx(j),Y(j)+Δy(j),Z(j)+Δz(j));
(k) repeating step (c) to step (h) till said ε(j)≦η.

9. The method according to claim 8 further comprises steps of establishing relationships between RSSI and distance in accordance with the environment of said space.

10. The method according to claim 8, wherein said adjustability is ranging from 0.000001 to 0.1.

11. The method according to claim 8, wherein said local gradient is a product of calculated distance and said error for each antenna.
